(19) United States
(12) Patent Application Publication
(10) Pub. No.: US 2018/0150598 A1
(43) Pub. Date: May 31, 2018

(54) METHODS AND SYSTEMS FOR COMPLIANCE ACCREDITATION FOR MEDICAL DIAGNOSTIC IMAGING

(71) Applicant: General Electric Company, Schenectady, NY (US)

(72) Inventors: Mark Robert Kohls, Wauwatosa, WI (US); Erik Steen, Moss (NO); Russell Fillingham, Chalfont St Giles (GB); Kathryn Watson, Chalfont St Giles (GB)

(21) Appl. No.: 15/365,449

(22) Filed: Nov. 30, 2016

(51) Int. Cl. G06F 19/00; G06T 7/00

(52) U.S. Cl. CPC G06F 19/321; G06T 7/0014; G06N 99/005; G06T 2207/10132; G06F 19/345

(57) ABSTRACT

Methods and systems are provided for automatically determining compliance of industry standard protocols and/or accreditation standards for medical diagnostic imaging, such as for ultrasound imaging systems. The systems and methods select a first medical image from a set of medical images, and identify a structure of interest based on a diagnostic selection. The diagnostic selection may represent a calibration mode or a certification mode. The systems and methods identify a measurement based on the structure of interest and the diagnostic selection, and generate advisory information for the medical diagnostic imaging system based on the measurement with respect to a predetermined threshold.

### BACKGROUND OF THE INVENTION

Embodiments described herein generally relate to automatically determining compliance of industry standard protocols and/or accreditation standards for medical diagnostic imaging, such as for ultrasound imaging systems.

Performing scans utilizing medical diagnostic imaging is technically challenging process. For example, operators performing cardiovascular examinations on an ultrasound imaging system must comply with various established protocols and standards of requirements that define a proper ultrasound examination. The protocol and standards are defined by set standard organizations such as the Intersocietal Accreditation Commission for Echocardiography in the USA, the British Society of Echocardiography in the United Kingdom, and/or the like. The operators are accredited by the commissions and standard board based on a review of particular image sets acquired by the operator and measured by the operator in an accreditation study.

However, there is no effective way for the operator to know either as an accreditation study is being performed or after the accreditation study is performed if the image sets and/or measurements meet the established standards other than having someone manually review the accreditation study. Given a volume of studies performed nationwide that is logistically impossible. Conventional methods for ultrasound accreditation by the standards organizations offer periodic “accreditation” to echo labs that meet their standards. This accreditation typically requires the echo lab to select certain studies performed during a given time period and send them to the accrediting organization for review. It is a very time consuming process that typically involves extracting images, removing patient health information, writing the image data to DVDs, and mailing the DVD's to the standards organizations. The standard organizations review and assess each image and/or measurement stored in the DVD to determine whether the operator has passed the accreditation requirements.

### BRIEF DESCRIPTION OF THE INVENTION

In an embodiment, a system is provided. The system includes a communication circuit configured to receive a set of medical images and at least one of corresponding measurement or calibration information from a remote medical diagnostic imaging system. The system includes a controller circuit having one or more processors coupled to the communication circuit. The controller circuit is configured to select a first medical image from the set of medical images, and identify a structure of interest based on a diagnostic selection. The diagnostic selection corresponding to a calibration mode or a certification mode. The controller circuit is further configured to identify a measurement based on the structure of interest and the diagnostic selection, and generate advisory information for the medical diagnostic imaging system based on the measurement with respect to a predetermined threshold.

In an embodiment, a method is provided. The method includes receiving a set of medical images and measurement or calibration information from a medical diagnostic imaging system. The method includes selecting a first medical image from the set of medical images, and identifying a structure of interest based on a diagnostic selection. The diagnostic selection corresponds to a calibration mode or a certification mode. The method includes identifying a measurement based on the structure of interest and the diagnostic selection, and generating advisory information for the medical diagnostic imaging system based on the measurement with respect to a predetermined threshold.

In an embodiment, a system is provided. The system includes an ultrasound imaging system configured to generate a set of medical images of a patient, a remote evaluation system having a communication circuit and a controller circuit. The communication circuit being communicatively coupled to the ultrasound imaging system. The communication circuit is configured to receive the set of medical images of the patient and an anatomical measurement. The controller circuit having one or more processors coupled to the communication circuit. The controller circuit is configured to select a first medical image from the set of medical images, and identify a structure of interest based on a certification mode.

### BRIEF DESCRIPTION OF THE DRAWINGS

FIG. 1 is a diagram illustrating a medical certification network, in accordance with an embodiment.

FIG. 2 is a schematic diagram of a remote evaluation system, in accordance with an embodiment.

FIG. 3 is a schematic diagram of an ultrasound imaging system, in accordance with an embodiment.

FIG. 4 is a flowchart of a method, in accordance with an embodiment.

FIG. 5 is an illustration of a medical image, in accordance with an embodiment.

FIG. 6 is an illustration of a medical image, in accordance with an embodiment.

### DETAILED DESCRIPTION OF THE INVENTION

The following detailed description of certain embodiments will be better understood when read in conjunction with the appended drawings. To the extent that the figures illustrate diagrams of the functional modules of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

It should be noted that although the various embodiments may be described in connection with an ultrasound imaging system, the methods and systems are not limited to ultrasound imaging or a particular configuration thereof. The various embodiments may be implemented in connection with different types of medical diagnostic imaging systems, including, for example, x-ray imaging systems, magnetic resonance imaging (MM) systems, computed-tomography (CT) imaging systems, positron emission tomography (PET) imaging systems, or combined imaging systems, among others.

Various embodiments described herein generally relate to automatically determining compliance of industry standard protocols and/or accreditation standards for medical diagnostic imaging, such as for ultrasound imaging systems. The medical diagnostic imaging system acquires a set of medical images, for example, utilizing an ultrasound probe. The set of medical images are transmitted to a remote evaluation system. The remote evaluation system is configured to automatically analyze the set of medical images for one or more structures of interest (e.g., anatomical structures). For example, the remote evaluation system may execute a machine learning algorithm (e.g., deep convolution neural network) to identify one or more structures of interest within the set of medical images. Based on an orientation and/or position of the structures of interest within the medical images the remote evaluation system may determine a diagnostic view of the medical image. Additionally or alternatively, an anatomical measurement may be received by the remote evaluation system from the medical diagnostic imaging system. For example, the remote evaluation system may compare and/or evaluate the anatomical measurement to a predetermined threshold (e.g., non-zero predetermined threshold). For example, the predetermined threshold may represent a range of values based on the structure of interest. In another example, the remote evaluation system may calculate a control measurement based on the structure of interest, and compare the control measurement with the anatomical measurement. Additionally or alternatively, the predetermined threshold may represent a non-numerical value. For example, the predetermined threshold may represent a detection (e.g., absence, presence) of an anatomical structure. Optionally, the remote evaluation system may generate advisory information based on the set of images and/or the anatomical measurement. For example, the remote evaluation system may notify the operator of the medical diagnostic imaging system to acquire additional medical images (e.g., missing image views), re-measure the structure of interest (e.g., anatomical measurement is outside non-zero predetermined threshold), and/or indicate the received medical images and/or anatomical measurements are acceptable for submission to the certification system.

A technical effect of at least one embodiment simplifies the process of accreditation of an operator and/or facility of the medical diagnostic imaging system. A technical effect of at least one embodiment provides instant feedback as to whether the examination complies with national and industry standards. A technical effect of at least one embodiment periodic accreditation could be performed with a simpler electronic versus a conventional DVD-based process. A technical effect of at least one embodiment provides a “continuous” accreditation score where a minimum number of examinations are scored as they are performed for accreditation.

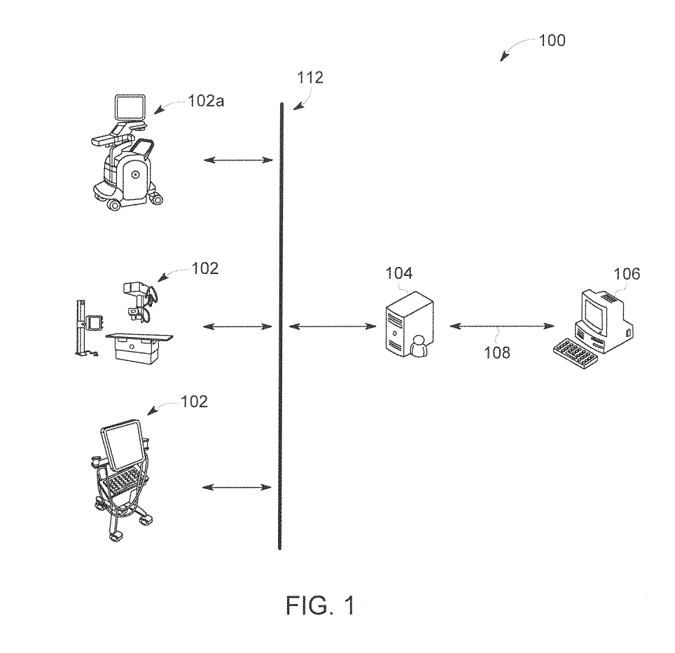

FIG. 1 illustrates a medical certification network (MCN) 100 in which various embodiments may be implemented. The MCN 100 may correspond to multiple departments within a medical facility or multiple locations at different medical facilities. In the illustrated embodiment, a plurality of medical diagnostic imaging systems 102 are operable to perform one or more medical examinations or scans. For example, the medical diagnostic imaging systems 102 may include ultrasound imaging systems or devices (e.g., the medical diagnostic imaging systems 102A), nuclear medicine imaging devices (e.g., Positron Emission Tomography (PET) or Single Photon Emission Computed Tomography (SPECT) imaging systems), Magnetic Resonance (MR) imaging devices, Computed Tomography (CT) imaging devices, and/or x-ray imaging devices, among others. It should be noted that although a description of the operation of an ultrasound imaging system in accordance with various embodiments is provided herein, the various embodiments may be implemented in connection with different ones of the medical diagnostic imaging systems 102 or other medical devices.

The medical diagnostic imaging systems 102 are communicatively coupled to a remote evaluation system 104 via one or more bi-directional communication links 112. The remote evaluation system 104 is communicatively coupled to one or more certification systems 106 via one or more bi-directional communication links 108. The remote evaluation system 104 may be a stand-alone computing device, a server, a peripheral device, and/or other processing machines. It should be noted in other embodiments the MCN 100 may include a plurality of remote evaluation systems 104 interconnected with each other.

The one or more bi-directional communication links 108, 112 may be any suitable wired and/or wireless connection. For example, the various components may be connected in a local area network (LAN) or similar type of arrangement. Additionally, the medical diagnostic imaging systems 102 may be coupled to the remote evaluation system 104 through the same or different bi-directional communication links 112, which may use the same or different communication protocols for transferring data there between. In various embodiments, the medical images and measurement or calibration information is communicated between the medical diagnostic imaging systems 102 and the remote evaluation system 104. In various embodiments, the measurement information may include physiological information (e.g., physiological measurements) of the patient, and/or anatomical measurements performed by the operator of the the medical diagnostic imaging systems 102. The calibration information may include information on a type of calibration phantom of the image. Additionally or alternatively, the remote evaluation system 104 may receive patient information (e.g., used to identify the patient, demographic information, protected health information (PHI), and/or the like), a diagnostic selection (e.g., calibration mode, certification mode, study more) to be performed using the particular medical diagnostic imaging system 102, and/or the like.

Additionally or alternatively, the one or more of the communication links 108, 112 may be encrypted. For example, the content of the medical images, measurement or calibration information, patient information and/or the like may be encrypted by the medical diagnostic imaging systems 102 and/or the remote evaluation system 104 using an Advanced Encryption Standard (AES) algorithm, an RSA algorithm standard (e.g., RSA-1024, RSA-2048), Secure Hash Algorithm (e.g., SHA-1, SHA-256, SHA-384, SHA-2), and/or the like.

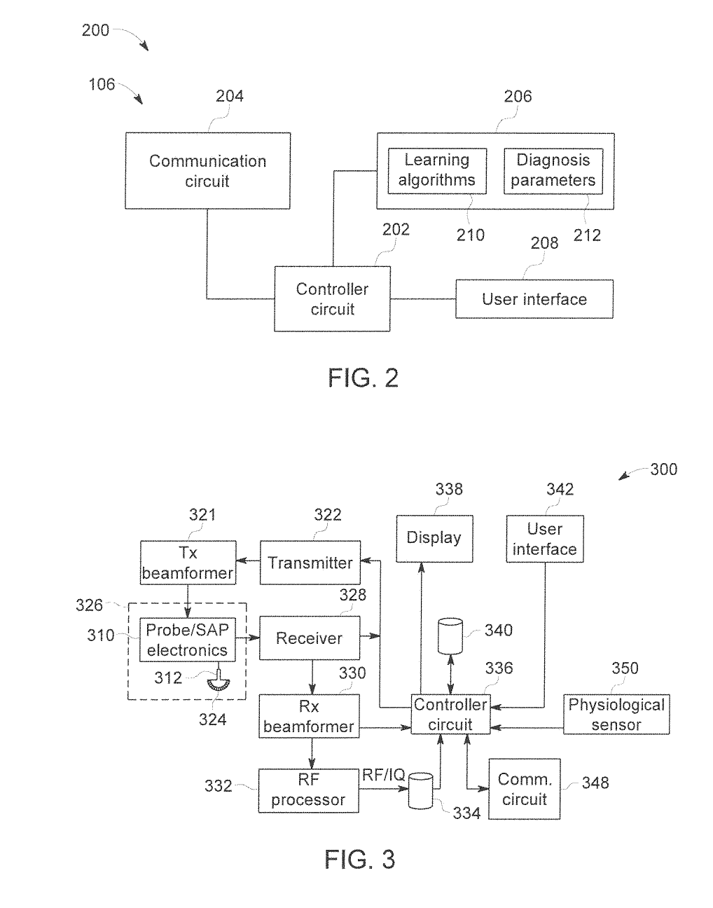

FIG. 2 illustrates a schematic diagram 200 of the remote evaluation system 104, in accordance with an embodiment. The remote evaluation system 104 includes a controller circuit 202 configured to control the operation of the remote evaluation system 104. The controller circuit 202 may include and/or represent one or more hardware circuits or circuitry that include, are connected with, or that both include and are connected with one or more processors, controllers, and/or other hardware logic-based devices. Additionally or alternatively, the controller circuit 202 may execute one or more programmed instructions stored on a tangible and non-transitory computer readable medium (e.g., memory 206) to perform one or more operations as described herein.

The controller circuit 202 may be operably coupled to and/or control a communication circuit 204. The communication circuit 204 is configured to receive and/or transmit information with the medical diagnostic imaging systems 102 and/or the certification system 106. The communication circuit 204 may represent hardware that is used to transmit and/or receive data along the one or more bi-directional communication links 108, 112. The communication circuit 204 may include a transceiver, receiver, transceiver and/or the like and associated circuitry (e.g., antennas) for wired and/or wirelessly communicating (e.g., transmitting and/or receiving) with the medical diagnostic imaging systems 102. For example, protocol firmware may be stored in the memory 206, which is accessed by the controller circuit 202. The protocol firmware provides the network protocol syntax for the controller circuit 202 to assemble data packets, establish and/or partition data received along the bi-directional communication links 108, 112.

The remote evaluation system 104 may include a user interface 208 configured to allow a user to directly or indirectly control operations of the remote evaluation system 104 and the various components thereof. The user interface 208 controls operations of the controller circuit 202 and is configured to receive inputs from the user. For example, the user interface 208 may include a keyboard, a mouse, a touchpad, a touchscreen, one or more physical buttons, and/or the like.

The memory 206 includes parameters, learning algorithms, data values, and/or the like utilized by the controller circuit 202 to perform one or more operations described herein. For example, the memory 206 includes a set of machine learning algorithms 210 (e.g., deep convolutional neural network algorithms, deep learning algorithms, decision tree learning algorithms, and/or the like). The machine learning algorithms 210 may be configured to identify one or more structures of interest based on features of the one or more structures of interest (e.g., boundaries, thickness, and/or the like) within the medical images received from the medical diagnostic imaging systems 102. The features may represent high level features of the structures of interest such as a histogram orient gradients, blob features, covariance features, binary pattern features, and/or the like. Optionally, the machine learning algorithm 210 is configured to automatically build a statistical model and/or a database of true positives and true negatives corresponding to each structure of interest for the machine learning algorithm 210 identified based on the features.

The machine learning algorithms 210 may be configured based on a plurality of training medical images. The plurality of training images may be grouped into different accreditation standard sets of training images. For example, a set of the training images may correspond to a cardiovascular accreditation having one or more structures of interest corresponding to cardiovascular anatomical structures. In another example, a second set of the training images may correspond to a pre-natal accreditation having one or more structures of interest corresponding to a fetal head, fetal heart, and/or the like.

Additionally or alternatively, the plurality of training images may include a set of calibration images based on using a calibration phantom. The calibration phantom is an object configured to simulate a patient or other target. The calibration phantom includes simulated features of varying size, shape, location, and density of acoustic and/or include a number of discrete fiducials arranged in a two-dimensional and/or three dimensional pattern forming one or more structure of interest. The calibration phantom is configured to allow an assessment of the performance of the diagnostic medical imaging system 102. Additionally or alternatively, the training images within each set may each represent different orientations and/or views of the one or more structures of interest. For example, each set of the training images may include over 50,000 medical images. The machine learning algorithm 210 may identify the one or more structures of interest based on high level features such as a histogram orient gradients, blob features, covariance features, binary pattern features, and/or the like.

Additionally or alternatively, the machine learning algorithm may be defined based on a supervised learning method. For example, a user (e.g., skilled medical practitioner) may manually label the one or more structures of interest within the plurality of training medical images utilizing the user interface 208. The manually labeled medical images may be used to build a statistical model and/or a database of true positives and true negatives corresponding to each structure of interest for the machine learning algorithm 210.

Optionally, the memory 206 may also include a set of diagnostic parameters 212. The diagnostic parameters 212 may include a plurality of physiological parameters and/or ranges. Each of the plurality of physiological parameters and/or ranges have a corresponding diagnosis and/or condition of the patient. The controller circuit 202 may compare the received physiological information within the measurement information to the diagnostic parameters 212 to determine a condition of the patient based on the physiological information.

For example, a set of the physiological parameters of the diagnostic parameters 212 may be associated with cardiac information, such as a heart rate. The controller circuit 202 may receive physiological information of the patient with a heart rate above 100 beats per minute. The controller circuit 202 may be configured to identify the physiological parameters and/or range of the diagnostic parameters 212 matching the 100 beats per minute. The identified physiological parameter and/or range may have a corresponding condition of tachycardia. Based on the identified physiological parameter and/or range, the controller circuit 202 may determine that the patient has a condition of tachycardia. In another example, the physiological information of the patient may correspond to a heart rate below 50 beats per minute. The controller circuit 202 may be configured to identify the physiological parameters and/or range of the diagnostic parameters 212 matching the 50 beats per minute. The identified physiological parameter and/or range may have a corresponding condition of bradycardia. Based on the identified physiological parameter and/or range, the controller circuit 202 may determine that the patient has a condition of bradycardia.

FIG. 3 illustrates a schematic block diagram of an ultrasound imaging system 300 according to one embodiment of the medical diagnostic imaging system 102. The ultrasound imaging system 300 may be a unitary apparatus such that the elements and components of the system 300 may be carried or moved with each other. The ultrasound imaging system 300 includes an ultrasound probe 326 having a transmitter 322 and probe/SAP electronics 310. The ultrasound probe 326 may be configured to acquire ultrasound data or information from a region of interest (e.g., organ, blood vessel) of the patient. The ultrasound probe 326 is communicatively coupled to a controller circuit 336 via the transmitter 322. The transmitter 322 transmits a signal to a transmit beamformer 321 based on acquisition settings received by the user. The signal transmitted by the transmitter 322 in turn drives the transducer elements 324 within the transducer array 312. The transducer elements 324 emit pulsed ultrasonic signals into a patient (e.g., a body). A variety of a geometries and configurations may be used for the array 312. Further, the array 312 of transducer elements 324 may be provided as part of, for example, different types of ultrasound probes.

The acquisition settings may define an amplitude, pulse width, frequency, and/or the like of the ultrasonic pulses emitted by the transducer elements 324. The acquisition settings may be adjusted by the user by selecting a gain setting, power, time gain compensation (TGC), resolution, and/or the like from the user interface 342.

The transducer elements 324, for example piezoelectric crystals, emit pulsed ultrasonic signals into a body (e.g., patient) or volume corresponding to the acquisition settings. The ultrasonic signals may include, for example, one or more reference pulses, one or more pushing pulses (e.g., shear-waves), and/or one or more tracking pulses. At least a portion of the pulsed ultrasonic signals back-scatter from a region of interest (ROI) (e.g., breast tissues, liver tissues, cardiac tissues, prostate tissues, and/or the like) to produce echoes. The echoes are delayed in time according to a depth, and are received by the transducer elements 324 within the transducer array 312. The ultrasonic signals may be used for imaging, for generating and/or tracking shear-waves, for measuring differences in compression displacement of the tissue (e.g., strain), and/or for therapy, among other uses. For example, the probe 326 may deliver low energy pulses during imaging and tracking, medium to high energy pulses to generate shear-waves, and high energy pulses during therapy.

The transducer array 312 may have a variety of array geometries and configurations for the transducer elements 324 which may be provided as part of, for example, different types of ultrasound probes 326. The probe/SAP electronics 310 may be used to control the switching of the transducer elements 324. The probe/SAP electronics 210 may also be used to group the transducer elements 324 into one or more sub-apertures.

The transducer elements 324 convert the received echo signals into electrical signals which may be received by a receiver 328. The electrical signals representing the received echoes are passed through a receive beamformer 330, which performs beamforming on the received echoes and outputs a radio frequency (RF) signal. The RF signal is then provided to an RF processor 332 that processes the RF signal. The RF processor 332 may generate different ultrasound image data types, e.g. B-mode, color Doppler (velocity/power/variance), tissue Doppler (velocity), and Doppler energy, for multiple scan planes or different scanning patterns. For example, the RF processor 332 may generate tissue Doppler data for multi-scan planes. The RF processor 332 gathers the information (e.g. I/Q, B-mode, color Doppler, tissue Doppler, and Doppler energy information) related to multiple data slices and stores the data information, which may include time stamp and orientation/rotation information, on the memory 334.

Alternatively, the RF processor 332 may include a complex demodulator (not shown) that demodulates the RF signal to form IQ data pairs representative of the echo signals. The RF or IQ signal data may then be provided directly to a memory 334 for storage (e.g., temporary storage). Optionally, the output of the beamformer 330 may be passed directly to the controller circuit 336.

The controller circuit 336 may be configured to process the acquired ultrasound data (e.g., RF signal data or IQ data pairs) and prepare frames of ultrasound image data for display on the display 338. The controller circuit 336 may include one or more processors. Optionally, the controller circuit 336 may include a central controller circuit (CPU), one or more microprocessors, a graphics controller circuit (GPU), or any other electronic component capable of processing inputted data according to specific logical instructions. Having the controller circuit 336 that includes a GPU may be advantageous for computation-intensive operations, such as volume-rendering. Additionally or alternatively, the controller circuit 336 may execute instructions stored on a tangible and non-transitory computer readable medium (e.g., the memory 340).

The controller circuit 336 is configured to perform one or more processing operations according to a plurality of selectable ultrasound modalities on the acquired ultrasound data, adjust or define the ultrasonic pulses emitted from the transducer elements 324, adjust one or more image display settings of components (e.g., ultrasound images, interface components) displayed on the display 338, and other operations as described herein. Acquired ultrasound data may be processed in real-time by the controller circuit 336 during a scanning or therapy session as the echo signals are received. Additionally or alternatively, the ultrasound data may be stored temporarily on the memory 334 during a scanning session and processed in less than real-time in a live or off-line operation.

The ultrasound imaging system 300 may include a memory 340 for storing processed frames of acquired ultrasound data that are not scheduled to be displayed immediately or to store post-processed images (e.g., shear-wave images, strain images), firmware or software corresponding to, for example, a graphical user interface, one or more default image display settings, and/or the like. The memory device 340 may be a tangible and non-transitory computer readable medium such as flash memory, RAM, ROM, EEPROM, and/or the like.

One or both of the memory 334 and 340 may store 3D ultrasound image data sets of the ultrasound data, where such 3D ultrasound image data sets are accessed to present 2D and 3D images. For example, a 3D ultrasound image data set may be mapped into the corresponding memory 334 or 340, as well as one or more reference planes. The processing of the ultrasound data, including the ultrasound image data sets, may be based in part on user inputs, for example, user selections received at the user interface 342.

Optionally, the controller circuit 336 is operably coupled to a physiological sensor 350. The physiological sensor 350 may be a cardiac sensor (e.g., heart rate monitor, EKG), temperature sensor, accelerometer, optical sensor, and/or the like. The physiological sensor 350 is configure to acquire physiological information of the patient, such as body temperature, heart rate, respiratory rate, and/or the like of the patient.

The controller circuit 336 is operably coupled to a communication circuit 348. The communication circuit 348 may be controlled by the controller circuit 336 and be configured to establish and detect communication links (e.g., the one or more bi-directional communication links 112) with the remote evaluation system 104. For example, the communication circuit 348 may include physical layer (PHY) components such as a transceiver, one or more communication ports, a digital signal processor, one or more amplifiers, an antenna, and/or the like for communicatively coupling the ultrasound imaging system 300 to the remote evaluation system 104. The communication circuit 348 may include one or more processors, a central controller circuit (CPU), one or more microprocessors, or any other electronic components capable of processing inputted data according to specific logical instructions.

The communication links established by the communication circuit 348 may conform to one or more communication protocols such as an Ethernet Standard, DICOM, USB, one or more wireless standards (e.g., 802.11, Bluetooth, Bluetooth Low Energy, ZigBee), and/or the like. The protocol firmware for the one or more communication protocols may be stored on the memory 340, which is accessible by the communication circuit 348 directly and/or via the controller circuit 336. Additionally or alternatively, the firmware may be stored within an internal memory of the communication circuit 348. The protocol firmware provide the communication protocol syntax for the communication circuit 348 to assemble data packets, establish one or more communication links, and/or partition data (e.g., advisory information) received from the remote evaluation system 104.

The controller circuit 336 is operably coupled to a display 338 and a user interface 342. The display 338 may include one or more liquid crystal displays (e.g., light emitting diode (LED) backlight), organic light emitting diode (OLED) displays, plasma displays, CRT displays, and/or the like. The display 338 may display patient information, a PHI workflow, ultrasound images and/or videos, components of a display interface, one or more 2D, 3D, or 4D ultrasound image data sets from ultrasound data stored on the memory 334 or 340 or currently being acquired, measurements, diagnosis, treatment information, and/or the like received by the display 338 from the controller circuit 336.

The user interface 342 may include hardware, firmware, software, or a combination thereof that enables an individual (e.g., an operator) to directly or indirectly control operation of the ultrasound system 300 and the various components thereof. The user interface 342 controls operations of the controller circuit 336 and is configured to receive inputs from the user. For example, the user interface 342 may include a keyboard, a mouse, a touchpad, one or more physical buttons, and/or the like. Optionally, the display 338 may be a touch screen display, which includes at least a portion of the user interface 342 shown as a graphical user interface (GUI). The touch screen display can detect a presence of a touch from the operator on the display 338 and can also identify a location of the touch in the display 338. For example, the user may select one or more user selectable elements shown on the display by touching or making contact with the display 338. The touch may be applied by, for example, at least one of an individual's hand, glove, stylus, or the like.

In various embodiments the user interface 342 (e.g., GUI) and the display 338 may communicates information to the operator by displaying the information to the operator. For example, the display 338 may present information to the operator during the imaging session. The information presented may include ultrasound images, graphical elements, user-selectable elements, and other information (e.g., administrative information, personal information of the patient, and the like). Additionally, the display 338 may display information received from the remote evaluation system 104 such as advisory information.

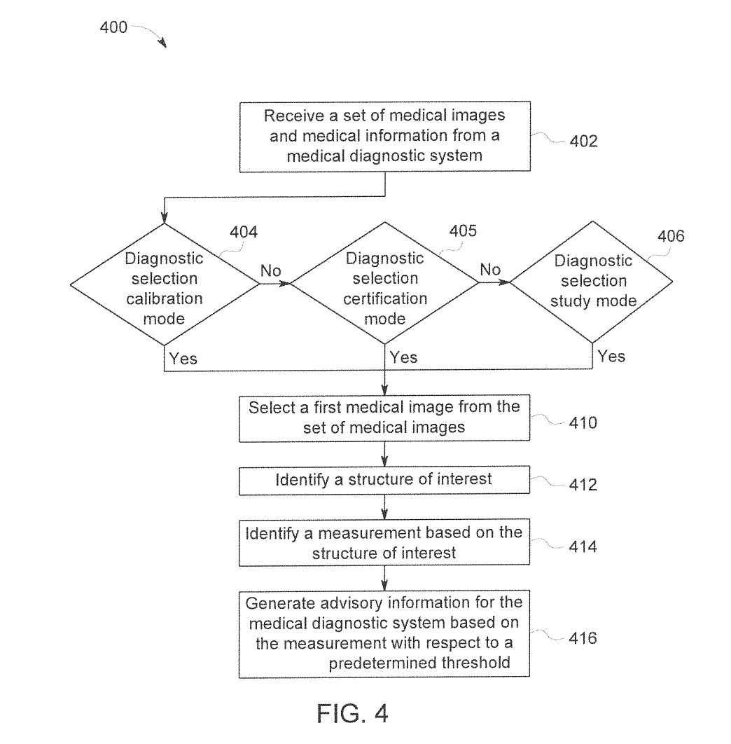

FIG. 4 illustrates a flowchart of a method 400 utilized by the MCN 100, in accordance with an embodiment. The method 400, for example, may employ structures or aspects of various embodiments (e.g., systems and/or methods) discussed herein. In various embodiments, certain steps (or operations) may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 400 may be used as one or more algorithms to direct hardware to perform one or more operations described herein.

Beginning at 402, the controller circuit 202 is configured to receive a set of medical images and at least one of measurement or calibration information from a remote medical diagnostic imaging system. For example, the ultrasound imaging system 200 may generate a set of medical images based on ultrasound data of a ROI, and generate and/or acquire the measurement or calibration information. The measurement information may include anatomical measurements of one or more medical images within the set of medical images, physiological information (e.g., physiological measurements) of the patient, and/or the like. The calibration information may include a model number and/or description of the calibration phantom imaged. Optionally, the controller circuit 202 may receive patient information (e.g., used to identify the patient, demographic information, protected health information (PHI), and/or the like), a diagnostic selection (e.g., calibration mode, certification mode, study more) to be performed using the particular medical diagnostic imaging system 102, and/or the like. For example, the patient information and/or the diagnostic selection may be entered by the operator of the ultrasound imaging system 200 utilizing the user interface 342. The physiological information may be acquired by the ultrasound imaging system 200 via the physiological sensor 350. Continually during the scan and/or when the scan is complete by the operators the communication circuit 348 may transmit the medical images and/or the measurement or calibration information along the one or more bi-directional communication links 112 to the remote evaluation system 104, which is subsequently received by the controller circuit 202 via communication circuit 204.

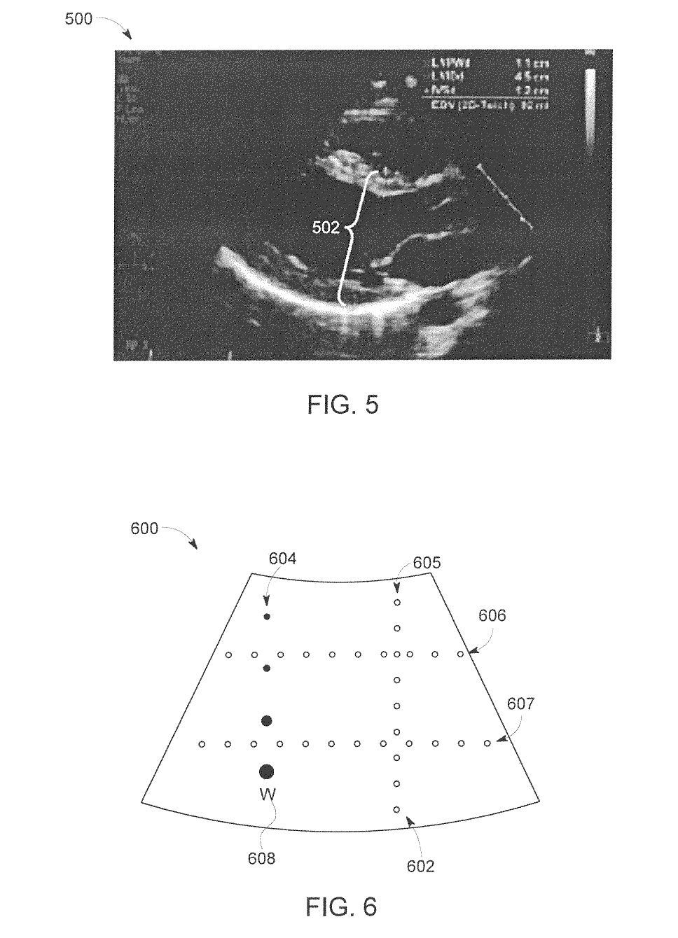

At 404-406, the controller circuit 202 may identify a diagnostic selection of the medical diagnostic imaging system. The diagnostic selection is configured to indicate to the remote evaluation system 104 a classification of the set of medical images received by the remote evaluation system 104. For example, the diagnostic selection may be a calibration mode, a certification mode, and/or a study mode. The calibration mode may indicate the set of medical images include one or more structures of interest representing a grid formation based on a calibration phantom (e.g., medical image 600 of FIG. 6). The certification mode may indicate the set of medical images include structures of interest and/or measurements related to a predetermined accreditation guideline (e.g., medical image 500 of FIG. 5). For example, the predetermined accreditation guideline may represent a set of protocols and standards are defined by set national standard organization for the medical diagnostic imaging system 102. The study mode may indicate the set of medical images include structure of interest and/or measurements to be included within a database stored in the memory 206.

Additionally or alternatively, the controller circuit 202 may be configured to remove identification information (e.g., patient name, address, account information, PHI, and/or the like) from the patient information. For example, the controller circuit 202 may store the set of medical images and/or measurements in the database stored in the memory 206. Each set of medical images and/or measurements have corresponding patient information. The controller circuit 202 may remove the identification information within the patient information leaving demographic information (e.g., age, race, height, weight, nationality, and/or the like). Additionally or alternatively, the controller circuit 202 may filter the identification information such that the identification information is not displayed.

At 410, the controller circuit 202 is configured to select a first medical image from the set of medical images. The first medical image may be selected based on when the medical image was received by the remote evaluation system 104, a selection by the operator of the medical diagnostic imaging system 102, based randomly, and/or the like. For example, the controller circuit 202 may select the medical image 500 shown in FIG. 5, from the set of medical images based on when the medical image 500 was received.

FIG. 5 is an illustration of the medical image 500, in accordance with an embodiment. The medical image 500 may have been acquired by the ultrasound imaging system 300 having a diagnostic selection corresponding to a certification mode. The medical image 500 may include a structure of interest, such as a left ventricle cavity of a patient. The medical image 500 may include one or more measurements, such as an anatomical measurement 502 within the measurement information. The anatomical measurements 502 may represent a wall thickness, cavity size, surface area, volume, and/or the like. The anatomical measurement 502 may have been designated by the operator of the medical diagnostic imaging system 102 associated with a predetermined accreditation guideline. The predetermined accreditation guideline may represent a series of measurements and/or image views of the one or more structures of interest defined by set national standard organization for the ultrasound imaging system 300. For example, the operator of the ultrasound imaging system 300 may request a cardiovascular certification for the ultrasound imaging system 300. Based on the cardiovascular certification, the operator may utilize the user interface 342 to acquire the anatomical measurement 502 to fulfill the cardiovascular certification such as a size of an internal diameter of the structure of interest (e.g., LVIDd, LVIDs).

At 412, the controller circuit 202 is configured to identify a structure of interest. For example, the controller circuit 202 may execute a statistical model and/or database generated by the machine learning algorithms 210 stored in the memory 206 based on the plurality of training medical images. For example, the controller circuit 202 may identify features (e.g., a histogram orient gradients, blob features, covariance features, binary pattern features, and/or the like) within the medical image 500 corresponding to the one or more structures of interest, such as the left ventricle cavity and/or anatomical boundaries of the left ventricle cavity.

Additionally or alternatively, the controller circuit 202 may be configured to determine a view of the medical image 500 based on an orientation of the structure of interest. For example, the controller circuit 202 may identify boundaries of the anatomical structure based on the features identified by the machine learning algorithm 210. Based on an orientation of the boundaries with respect to the medical image, the controller circuit 202 may determine a view of the medical image 500. Optionally, the controller circuit 202 may determine a view of the medical image 500 based on the structure of interest and the diagnostic selection. For example, the diagnostic selection may be the calibration mode. The controller circuit 202 may match an identified structure of interest with the predetermined accreditation guideline to determine a view. For example, the controller circuit 202 may identify the structure of interest as a left ventricle outflow tract, which matches a view of a medical image defined by the predetermined accreditation guideline.

At 414, the controller circuit 202 is configured to identify a measurement based on the structure of interest. For example, the controller circuit 202 may be configured to identify the anatomical measurement 502 of the medical image received from the medical diagnostic imaging system 102 via the bi-directional communication link 112. Additionally or alternatively, the controller circuit 202 may be configured to automatically determine a measurement based on the features of the structure of interest, such as a thickness, volume, surface area, and/or the like. For example, in connection with the medical image 500, the controller circuit 202 may identify an outer perimeter of the boundary of the structure of interest and an interior region in contact with the boundary. The controller circuit 202 may determine a wall thickness of the structure of interest based on a difference in position between the outer perimeter of the boundary and the interior region.

At 416, the controller circuit 202 is configured to generate advisory information for the medical diagnostic imaging system 102 based on the measurement with respect to a predetermined threshold. The advisory information may be based on the diagnostic selection. For example, the calibration mode and the certification mode may each have different advisory information generated by the controller circuit 202.

For example, during the certification mode the advisory information may include instructions to acquire one or more additional medical images and/or to adjust the measurement. In an embodiment, the controller circuit 202 may compare the views of medical images and/or the identified structures of interest with the predetermined accreditation guidelines. If one or more of the views and/or the identified structures of interest are missing and/or unaccounted for within the set of medical images, the controller circuit 202 may include in the advisory information that an additional medical image that represents the missing and/or unaccounted view and/or structure of interest is needed. Additionally or alternatively, the controller circuit 202 may compare the measurements with a predetermined threshold. The predetermined threshold may be defined based on the predetermined accreditation guideline and the structure of interest. For example, the predetermined accreditation guideline may include a range of measurement values with corresponding structures of interest. The range of measurement values may be based on priori information. Additionally or alternatively, the range of measurement values may be grouped into demographical groups. For example, the predetermined threshold may be selected by the controller circuit 202 based on the patient information. For example, the controller circuit 202 may select the range of measurement values based on the demographical information (e.g., sex, race, height, weight, nationality, age, and/or the like). The controller circuit 202 may compare the identified measurement, such as the anatomical measurement 502, with the predetermined threshold. If the identified measurement is above and/or outside the predetermined threshold, the controller circuit 202 may include in the advisory information that to adjust the identified measurement.

Additionally or alternatively, the predetermined threshold may be based on a measurement acquired by the controller circuit 202. For example, predetermined threshold may represent a set difference between the identified measurement (e.g., the anatomical measurement 502) and a measurement determined by the controller circuit 202. The controller circuit 202 may be configured to determine a measurement based on the features of the structure of interest, such as a thickness, volume, surface area, and/or the like representative of the identified measurement. The controller circuit 202 may compare the measurement received from the medical diagnostic imaging system 102 (e.g., the anatomical measurement 502) with the measurement determined by the controller circuit 202. If the difference between measurements is above the predetermined threshold, the controller circuit 202 may include in the advisory information that to adjust the identified measurement.

Additionally or alternatively, if the measurement is within the predetermined threshold during the calibration mode the controller circuit 202 may be configured to generate a certification report that includes the set of medical images and the identified measurement. The certification report may represent the set of medical images and/or measurements acquired by the medical diagnostic imaging system 102. For example, the certification report may include the required set of medical images and/or measurements for the operator for certification. When the certification report is prepared, the controller circuit 202 may transmit the certification report to the one or more certification systems 106. Optionally, the controller circuit 202 may group multiple certification reports together, such as operators of one or more medical facilities, when transmitting the certification reports to the one or more certification systems 106.

Additionally or alternatively, the predetermined threshold may represent a non-numerical value such as a detection (e.g., absence, presence) of an anatomical structure, view of the anatomical structure, characteristic of the anatomical structure, and/or the like. For example, the predetermined threshold may represent identification of a growth and/or stenosis on the anatomical structure. The controller circuit 202 executing the machine learning algorithms 210 may identify a growth or stenosis on the anatomical structure. Based on the identification of the growth and/or stenosis, the controller circuit 202 may determine that the predetermined threshold has been met.

In an embodiment, the advisory information may be associated with an operation status of the medical diagnostic imaging system 102. For example, during the calibration mode of the diagnostic selection the controller circuit 202 may receive a set of medical images (e.g., the medical image 600) based on the calibration phantom. The controller circuit 202 may determine an operation status of the medical diagnostic imaging system 102 based on the set of medical images of the calibration phantom.

FIG. 6 is an illustration of the medical image 600, in accordance with an embodiment. The medical image 600 may have been acquired by the ultrasound imaging system 300 having a diagnostic selection corresponding to a calibration mode. The medical image 600 may include a structure of interest representing a grid formation 602. The grid formation 602 includes a plurality discrete fiducials 605-607 arranged in a two-dimensional pattern based on a model number and/or description of the calibration phantom within the calibration information. Based on a position and/or size (e.g., diameter 604) of the discrete fiducials 605-606 the controller circuit 202 may determine an operation status of the ultrasound probe 326. For example, the controller circuit 202 may select the medical image 600 from a set of medical images received from the ultrasound imaging system 300. The controller circuit 202 may determine the operation status based on a position of the discrete fiducials 604-607 with respect to each other, a size of the discrete fiducials 608, and/or the like representing the structure of interest. For example, the controller circuit 202 may identify the discrete fiducials 604-607 by executing the machine learning algorithms 210 based on the features of structure of interest such as a histogram orient gradients, blob features, covariance features, binary pattern features, and/or the like and the calibration information. The controller circuit 202 may automatically measure a proximity between the discrete fiducials 605-607 for the identified measurement. For example, the predetermined threshold may represent a set distance between the discrete fiducials 604-607. The controller circuit 202 may determine changes in the proximity between the discrete fiducials 604-607 above the predetermined threshold may indicate discrete fiducials missed and/or omitted by the ultrasound probe 326. Additionally or alternatively, the predetermined threshold may be based on a diameter 608 of one or more discrete fiducials 604. For example, the controller circuit 202 may determine when the diameter 608 is above the predetermined threshold may indicate the ultrasound probe 326 is not receiving reflected ultrasound signals emitted from the transducer elements 324.

If the identified measurement is above and/or outside the predetermined threshold, the controller circuit 202 may include in the advisory information that the operation status of the ultrasound probe 326 and/or the ultrasound imaging system 300 is at fault and/or error. Alternatively, if the identified measurement is within the predetermined threshold, the controller circuit 202 may include in the advisory information that the operation status of the ultrasound probe 326 and/or the ultrasound imaging system 300 is good and/or within specification.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid-state drive, optical disk drive, and the like. The storage device may also be other similar means for loading computer programs or other instructions into the computer or processor.

As used herein, the term “computer,” “subsystem” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation. For example, a controller circuit, processor, or computer that is “configured to” perform a task or operation may be understood as being particularly structured to perform the task or operation (e.g., having one or more programs or instructions stored thereon or used in conjunction therewith tailored or intended to perform the task or operation, and/or having an arrangement of processing circuitry tailored or intended to perform the task or operation). For the purposes of clarity and the avoidance of doubt, a general purpose computer (which may become “configured to” perform the task or operation if appropriately programmed) is not “configured to” perform a task or operation unless or until specifically programmed or structurally modified to perform the task or operation.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f) unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A system, comprising:
a communication circuit configured to receive a set of medical images and at least one of corresponding measurement or calibration information from a remote medical diagnostic imaging system;
a controller circuit having one or more processors coupled to the communication circuit, the controller circuit configured to:
select a first medical image from the set of medical images;
identify a structure of interest based on a diagnostic selection, wherein the diagnostic selection is a calibration mode or a certification mode;
identify a measurement based on the structure of interest and the diagnostic selection; and
generate advisory information for the medical diagnostic imaging system based on the measurement with respect to a predetermined threshold.

2. The system of claim 1, wherein the diagnostic selection corresponds to a certification mode, the communication circuit is configured to receive the measurement from the medical diagnostic imaging system, wherein the measurement represent an anatomical measurement.

3. The system of claim 2, wherein the advisory information includes instructions to acquire an additional medical image or to adjust the anatomical measurement.

4. The system of claim 2, wherein the anatomical measurement is associated with a predetermined accreditation guideline.

5. The system of claim 2, wherein the controller circuit is configured to generate a certification report that includes the first medical image and the anatomical measurement, the communication circuit being configured to transmit the certification report to the certification system.

6. The system of claim 2, wherein the controller circuit is configured to determine a view of the first medical image based on an orientation of the structure of interest.

7. The system of claim 1, wherein the measurement or calibration information includes patient health information, the controller circuit is configured to remove identification information from the measurement or calibration information.

8. The system of claim 1, wherein the diagnostic selection corresponds to a calibration mode, the structure of interest representing a grid formation.

9. The system of claim 8, wherein the advisory information is associated with an operation status of an ultrasound probe of the medical diagnostic imaging system.

10. The system of claim 1, wherein the measurement or calibration information includes physiological information of a patient, the controller circuit is configured to determine a condition of the patient based on the physiological information.

11. The system of claim 1, wherein the structure of interest is identified based on a machine learning algorithm executed by the controller circuit.

12. A method comprising:
receiving a set of medical images and measurement or calibration information from a medical diagnostic imaging system;
selecting a first medical image from the set of medical images;
identifying a structure of interest based on a diagnostic selection, wherein the diagnostic selection is a calibration mode or a certification mode;
identifying a measurement based on the structure of interest and the diagnostic selection; and
generating advisory information for the medical diagnostic imaging system based on the measurement with respect to a predetermined threshold.

13. The method of claim 12, wherein the diagnostic selection corresponds to a certification mode, and
receiving the measurement from the medical diagnostic imaging system, wherein the measurement represents an anatomical measurement.

14. The method of claim 13, wherein the advisory information includes instructions to acquire an additional medical image or to adjust the anatomical measurement.

15. The method of claim 13, further comprising generating a certification report that includes the first medical image and the anatomical measurement, and transmitting the certification report to a certification system.

16. The method of claim 13, further comprising determining a view of the first medical image based on an orientation of the structure of interest.

17. The method of claim 12, wherein the diagnostic selection corresponds to a calibration mode, the structure of interest representing a grid formation, the advisory information is associated with an operation status of an ultrasound probe of the medical diagnostic imaging system.

18. The method of claim 12, wherein the measurement or calibration information includes physiological information of a patient; and
determining a condition of the patient based on the physiological information.

19. A system comprising:
an ultrasound imaging system configured to generate a set of medical images of a patient; and
a remote evaluation system having a communication circuit and a controller circuit, the communication circuit being communicatively coupled to the ultrasound imaging system, wherein the communication circuit is configured to receive the set of medical images of the patient and an anatomical measurement, the controller circuit having one or more processors coupled to the communication circuit, the controller circuit configured to:
select a first medical image from the set of medical images; and
identify a structure of interest based on a certification mode.

20. The system of claim 19, wherein the controller circuit is configured to determine a measurement based on the structure of interest, and generate advisory information for the medical diagnostic imaging system based on the measurement with respect to a predetermined threshold, the measurement is based on a predetermined accreditation guideline, the predetermined threshold is based on the measurement; and
further comprising a certification system, wherein the certification system is communicatively coupled to the remote evaluation system, the controller circuit being configured to generate a certification report that includes the first medical image and the measurement, and the communication circuit is configured to transmit the certification report to the certification system.
